(19) United States
(12) Patent Application Publication
(10) Pub. No.: US 2020/0378160 A1
(43) Pub. Date: Dec. 3, 2020

(54) CASE BODY WITH A DOUBLE-TOGGLE LOCKSET

(71) Applicant: Tsung-Chi CHEN, Taichung City (TW)

(72) Inventor: Tsung-Chi CHEN, Taichung City (TW)

(21) Appl. No.: 16/429,727

(22) Filed: Jun. 3, 2019

(51) Int. Cl. E05B 65/52; B25H 3/02; A45C 5/03; A45D 40/00; E05C 9/04; E05C 19/10; E05B 37/02

(52) U.S. Cl. CPC E05B 65/5215; B25H 3/02; A45C 5/03; E05Y 2900/602; E05C 9/047; E05C 19/10; E05B 37/02; A45D 40/00

(57) ABSTRACT

A case body with a double-toggle lockset, which includes a first case and a second case which are pivoted on each other. The main feature is that a double-toggle lockset is provided on the lift side of the second case, which includes a casing holder, a core, two pull parts and two linked buckle components, wherein the distance between the toggles of the two pull parts is in the range which allows a normal adult to pull the toggles with one hand. When the locking component of core is in release mode, the user can pull the toggles of the two pull parts to drive the two linked buckle components, so that the buckle parts are released from the locating hooks of the first case, the first and second cases can be opened.

### CROSS-REFERENCE TO RELATED U.S. APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO AN APPENDIX SUBMITTED ON COMPACT DISC

Not applicable.

### BACKGROUND OF THE INVENTION

### 1. Field of the Invention

The present invention relates generally to a case body, and more particularly to an innovative case body structure type with a double-toggle lockset.

### 2. Description of Related Art Including Information Disclosed Under 37 CFR 1.97 and 37 CFR 1.98

The case body indicated in the present invention generally refers to the case body type with a turning lift second case, such as suitcase, cosmetics case and toolbox.

In the existing case body structure design, the lockset is always a very important part, and related circles improve and break through the lockset structure of case body continuously Taking a general view of the lockset of the known case body, two spaced locksets are usually provided on the lift side of the second case, this form is quite universal and popular for a long time, but the defect is that both of the two locksets must be provided with a core, and they must be operated with both hands at the same time, the components are too complex and the use is inconvenient. Based on this, related circles developed another known case body lockset type with one knob and two laterally extended linked components for localizing or releasing two spaced fasteners synchronously. This type has less components and more convenient operation, but the knob is usually designed as a protruding shape for convenient gripping and turning, thus, the prominent shape influences the overall esthetics and value of case body, and the knob is likely to be damaged by collision with foreign objects, or to rotate arbitrarily under exogenic action to open the second case by accident. Therefore, how to develop an innovative case body lockset structure type with more ideal practicability is an important technical topic the related circles shall further notice and think about.

### BRIEF SUMMARY OF THE INVENTION

The primary object of the present invention is to provide a case body with a double-toggle lockset. The technical problem to be solved is to break through how to develop a novel case body structure type with more ideal practicability.

Based on said purpose, the present invention provides a case body with a double-toggle lockset. Said case body comprises a first case and a second case which are pivoted on each other, wherein the second case has a lift side, the first case has two spaced locating hooks, the two locating hooks correspond to the lift side of the second case; a double-toggle lockset, installed on the lift side of the second case, the double-toggle lockset comprises a casing holder with a storage space and an operation panel; a core located somewhere in the storage space of casing holder, the core has an operating part and a locking component, the locking component has a lock mode and a release mode, the operating part is exposed on the operation panel of casing holder, and the operating part switches the lock mode or release mode of locking component; two pull parts, located in the storage space of casing holder and symmetrically spaced on two opposite sides of core, each pull part comprises a toggle, a guide base, a brake part and an elastic reset piece, wherein the toggle is exposed on the operation panel of casing holder for manual pull, the guide base is connected to the toggle, so that the guide base and toggle move synchronously, the brake part is connected to a position of guide base, the brake part fits the locking component of core, the locking component in lock mode or release mode forms the localized state or movable state of brake part with toggle and guide base; the elastic reset piece is located between the fixed part and guide base in the storage space, so that the actuation of guide base and toggle can be resetted automatically; two linked buckle components, located in the storage space of casing holder and on the opposite outer sides of two pull parts respectively, each linked buckle component comprises a moved part, a buckle part and an extended interlocking frame between the moved part and buckle part, wherein the moved part is connected to the guide base of the corresponding pull part, the buckle part is stuck in the corresponding locating hook of the first case, so as to localize the second case covering the first case; and the distance between the toggles of two pull parts is in the range a normal adult can pull the toggles with one hand.

Based on the innovative unique structure type and technical characteristics, in comparison to previous technique, the present invention can provide an innovative case body structure type with a double-toggle lockset, the configuration of two linked buckle components and two locating hooks can implement the better positioning effect of spaced locating points, based on the morphological feature that the distance between the toggles of the two pull parts is in the range which allows a normal adult to pull the toggles with one hand, the user can easily open the lockset of case body by pulling the double-toggle lockset of the present invention with one hand, the operation is more convenient. In addition, the toggles of the two pull parts must be pulled simultaneously for unlocking, there is better practical progressiveness of preventing the lockset of case body from being unlocked by the collision with an external force.

Another object of the present invention is to use another technical feature that a guide cavity for holding an elastic underprop component is located in the buckle part position near each linked buckle component in the storage space of the casing holder, when the buckle part of the linked buckle component is disengaged from the locating hook to present the unlocking condition, under the elastic underpropping effect of the elastic underprop component on the locating hook, the first and second cases are pulled off automatically to form a spacing, so as to provide a gap for the user's finger to enter and pull, it is more laborsaving and more convenient to open the case body.

The third object of the present invention is to use another technical feature that an auxiliary locating hook is located in the gap of at least one of the two locating hooks of the first case, so as to increase the gripper locating points according to the width of case body, further enhancing the advantage and practical progressiveness of firmness of case body in closed state and product quality.

### BRIEF DESCRIPTION OF THE SEVERAL VIEWS OF THE DRAWINGS

FIG. 1 is the stereogram of the second case in lifted state in the preferred embodiment of the case body of the present invention.

FIG. 2 is the three-dimensional outside view of the preferred embodiment of double-toggle lockset of the present invention.

FIG. 3 is the stereogram of double-toggle lockset and two locating hooks of the present invention in combined state (note: partially perspective).

FIG. 4 is the exploded view of partial components in the preferred embodiment of double-toggle lockset of the present invention.

FIG. 5 is the longitudinal section view of relevant components of the locking component of the present invention in lock mode.

FIG. 6 is the close-up view 1 of FIG. 5.

FIG. 7 is the close-up view 2 of FIG. 5.

FIG. 8 is the longitudinal section view of relevant components of locking component of the present invention in release mode.

FIG. 9 is the schematic diagram of pull part and linked buckle component in actuation when the locking component of the present invention is in release mode.

FIG. 10 is the schematic diagram of the hand pulled toggles of two pull parts of the present invention.

FIG. 11 is the three-dimensional outside view of the embodiment of coded lock on/off type as core operating part of the present invention.

FIG. 12 is the schematic diagram of lock mode of the locking component of embodiment disclosed in FIG. 11.

FIG. 13 is the schematic diagram of release mode of the locking component of embodiment disclosed in FIG. 11.

FIG. 14 is the embodiment diagram 1 of the present invention with auxiliary locating hooks.

FIG. 15 is the embodiment diagram 2 of the present invention with auxiliary locating hooks.

### DETAILED DESCRIPTION OF THE INVENTION

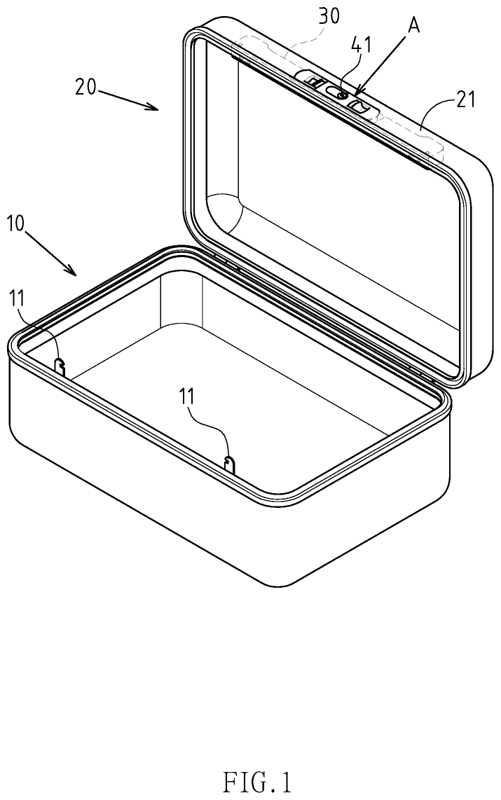

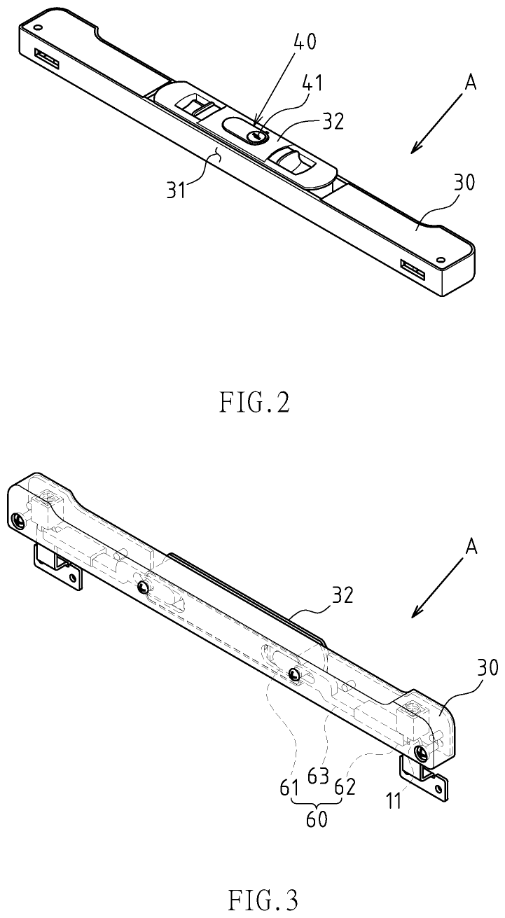

Referring to FIGS. 1 to 4 for the preferred embodiments of the case body with a double-toggle lockset of the present invention, but the embodiments are for illustration only, the patent application is not limited to this structure.

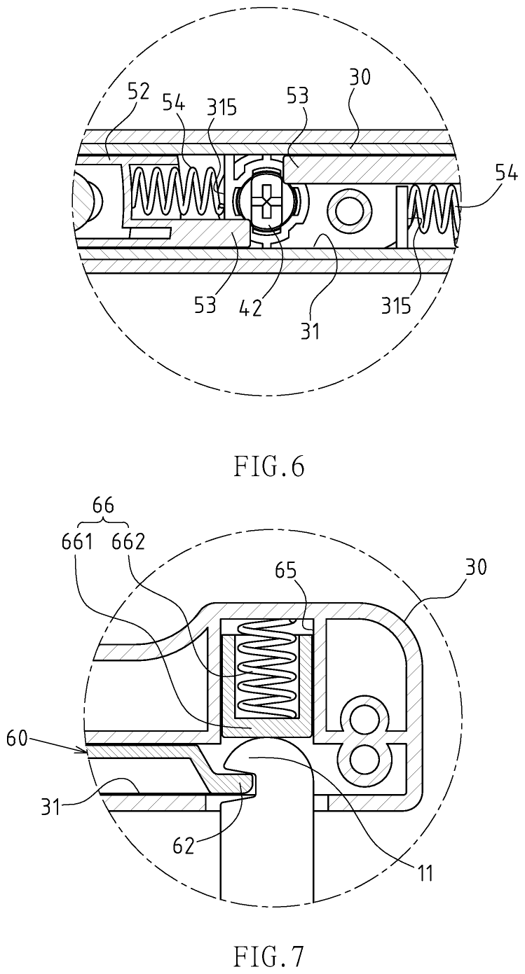

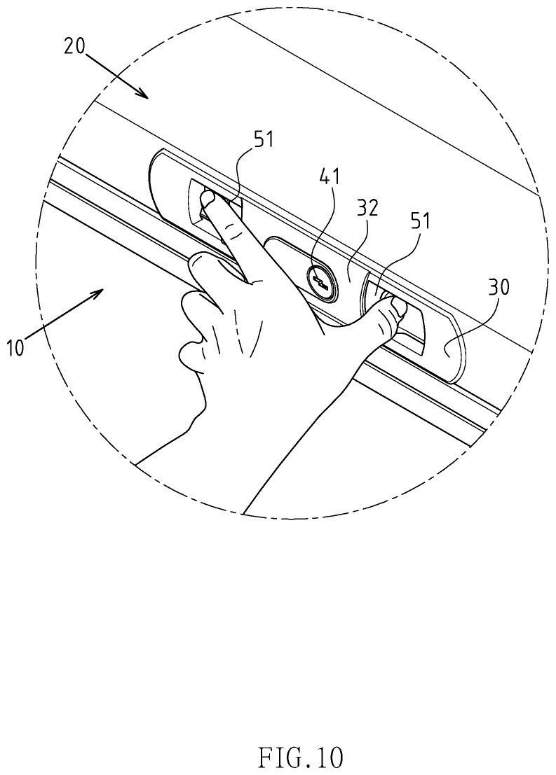

Said case body comprises a first case 10 and a second case 20 which are pivoted on each other, wherein the second case 20 has a lift side 21, the first case 10 has two spaced locating hooks 11, the two locating hooks 11 correspond to the lift side 21 of the second case 20; a double-toggle lockset A, installed on the lift side of the second case 20, the double-toggle lockset A comprises a casing holder 30 with a storage space 31 and an operation panel 32; a core 40 located somewhere in the storage space 31 of the casing holder 30, the core 40 has an operating part 41 and a locking component 42, the locking component 42 has a lock mode and a release mode, the operating part 41 is exposed on the operation panel 32 of the casing holder 30, and the operating part 41 is used to switch said lock mode or release mode of the locking component 42; two pull parts 50 located in the storage space 31 of the casing holder 30, symmetrically spaced on two opposite sides of the core 40, each pull part 50 comprises a toggle 51, a guide base 52, a brake part 53 and an elastic reset piece 54 (can be but not limited to a helical spring), wherein the toggle 51 is exposed on the operation panel 32 of the casing holder 30 for the finger to pull (as shown in FIG. 10), the guide base 52 is connected to the toggle 51, so that the guide base 52 and the toggle 51 move synchronously, the brake part 53 is connected to a position of the guide base 52, the brake part 53 fits the locking component 42 of the core 40, and the locking component 42 in said lock mode or release mode localizes or moves the brake part 53 together with the toggle 51 and the guide base 52; the elastic reset piece 54 is located between a fixed part 315 (only shown in FIG. 6) and the guide base 52 in the holding space 31, so that the actuation of the guide base 52 and the toggle 51 can be resetted automatically; two linked buckle components 60, located in the storage space 31 of the casing holder 30 and on opposite outer sides of the two pull parts 50 respectively, each linked buckle component 60 comprises a moved part 61, a buckle part 62 and an extended interlocking frame 63 between the moved part 61 and the buckle part 62, wherein the moved part 61 is connected to the guide base 52 of the corresponding pull part 50, the buckle part 62 is stuck in the corresponding locating hook 11 of the first case 10, so as to localize the second case 20 covering the first case 10; wherein the distance between the toggles 51 of the two pull parts 50 is in the range which allows a normal adult to pull the toggles with one hand (see the state shown in FIG. 10).

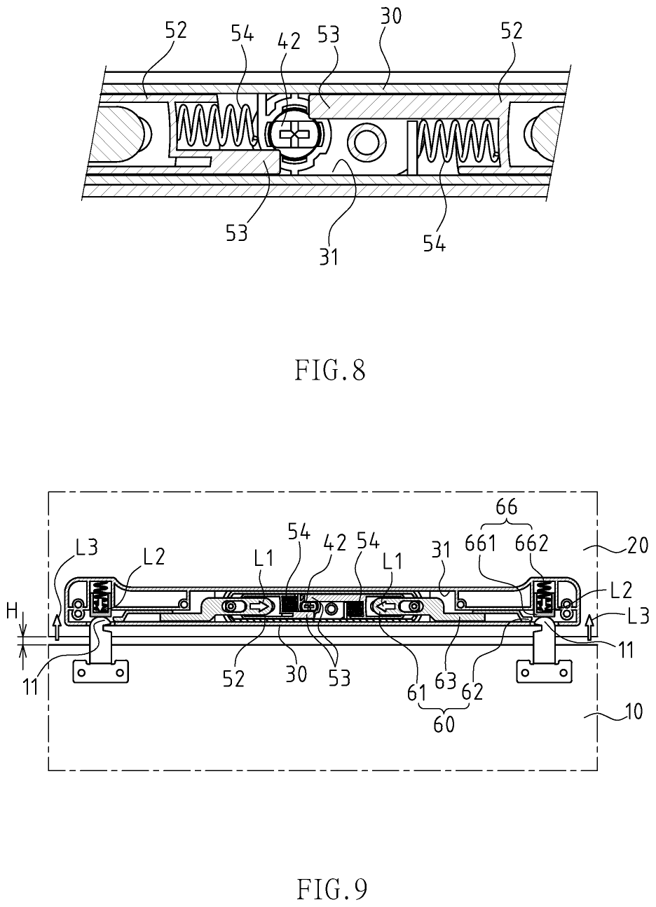

As shown in FIGS. 1 to 7, in this case, the operating part 41 of the core 40 is key turn on/off type, the locking component 42 is a T-bar turning synchronously with the operating part 41; the brake part 53 of the two pull parts 50 is a laterally protruding bolt, and the brake parts 53 of the two pull parts 50 are vertically dislocated and spaced (as shown in FIG. 6); said lock mode is formed when the locking component 42 turns to an upright angle as shown in FIG. 6, so that the brake parts 53 of the two pull parts 50 are localized; said release mode is formed when the locking component 42 turns to a transverse angle as shown in FIG. 8, so that the brake parts 53 of the two pull parts 50 are released for actuation, Referring to FIG. 10 for this state, the two toggles 51 can be pulled with one hand, so as to drive the guide base 52 of two pull parts 50 together with two linked buckle components 60 to shift in opposite directions (Arrow L1), and the buckle part 62 of linked buckle component 60 is disengaged from the corresponding locating hook 11 of the first case 10. Thus, the second case 20 can be opened. It must be noted in this case that the specific structure of the key turn on/off type operating part 41 of the core 40 is of the known technology, and not the category protected for the present invention, so it is not detailed herein.

As shown in FIGS. 5 and 7, in this case, a guide cavity 65 for holding an elastic underprop component 66 is provided near the buckle part 62 of the linked buckle component 60 in the storage space 31 of the casing holder 30, the elastic underprop component 66 comprises an underprop holder 661 and an elastic piece 662, wherein the end of the underprop holder 661 props the end of the corresponding locating hook 11 of the first case 10, when the buckle part 62 of the linked buckle component 60 is disengaged from the locating hook 11, as shown in FIG. 9, under the elastic underpropping effect of the elastic underprop component 66 on the locating hook 11 (Arrow L2), the second case 20 and the first case 10 are pulled off automatically (Arrow L3) to form a spacing H; said spacing H in this case provides a gap for the user's finger to enter and pull, it is more laborsaving and convenient to open the case body.

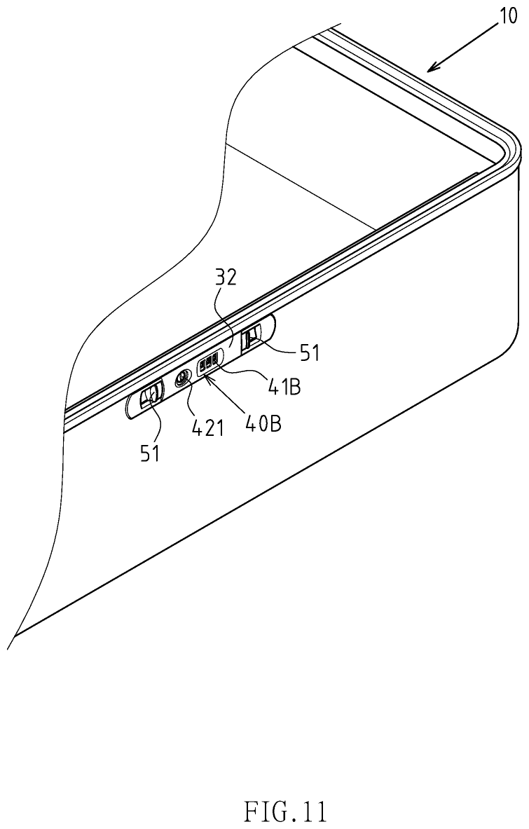

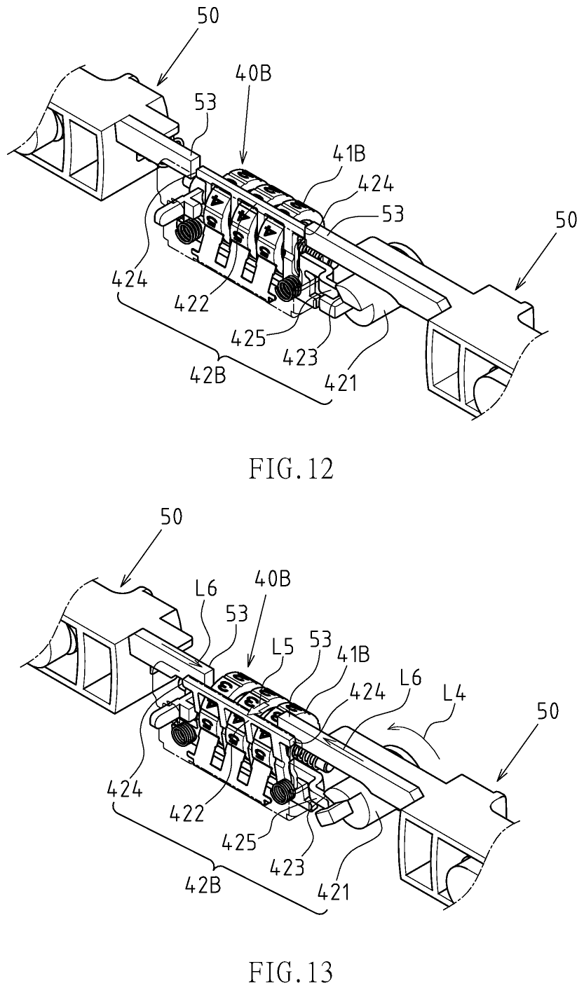

As shown in FIGS. 11 to 13, in this case, the operating part 41B of the core 40B is coded lock on/off type, the locking component 42B comprises a rotary knob 421 and a swing frame 422, wherein one end of the rotary knob 421 has a bevel guide face 423, there are two propping parts 424 on two opposite sides of the swing frame 422 for the brake parts 53 of the two pull parts 50 to prop, and one side of the swing frame 422 is provided with a pushed part 425 which cooperates with the bevel guide face 423 of the rotary knob 421. The coded lock on/off type operating part 41B in unlock status is shown in FIG. 13, the swing frame 422 can swing, and the locking component 42B is in release mode. In this state, the user turns the rotary knob 421 (Arrow L4), the bevel guide face 423 pushes the pushed part 425, the two propping parts 424 of the swing frame 422 shift (Arrow L5), the brake parts 53 of the two pull parts 50 are released for actuation (Arrow L6). It must be noted in this case that the specific structure of the coded lock on/off type operating part 41B of the core 40B is of the known technology, and not in the category protected for the present invention, so it is not detailed herein.

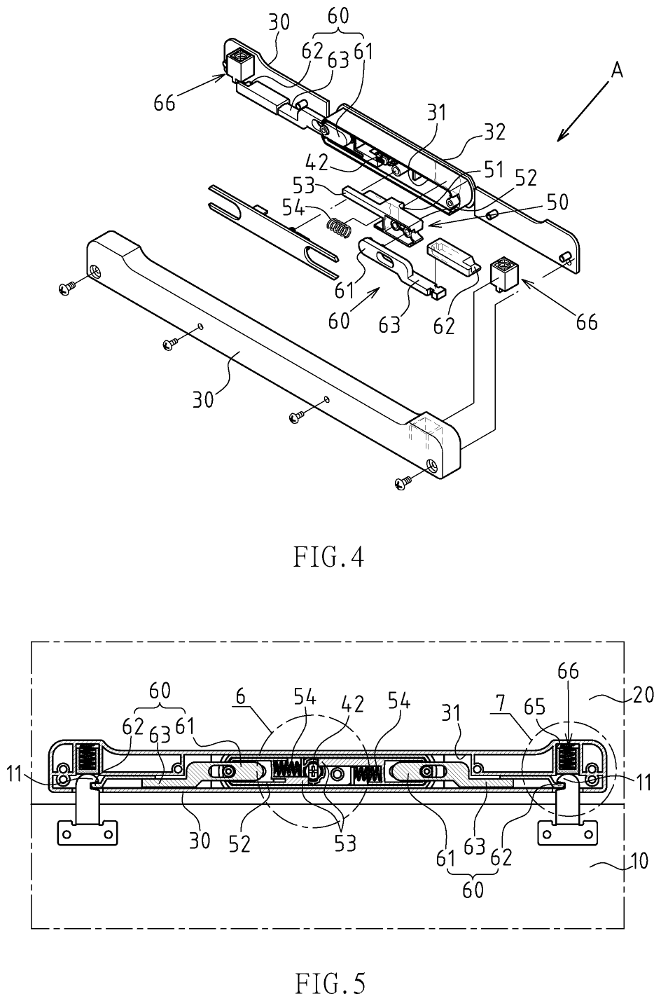

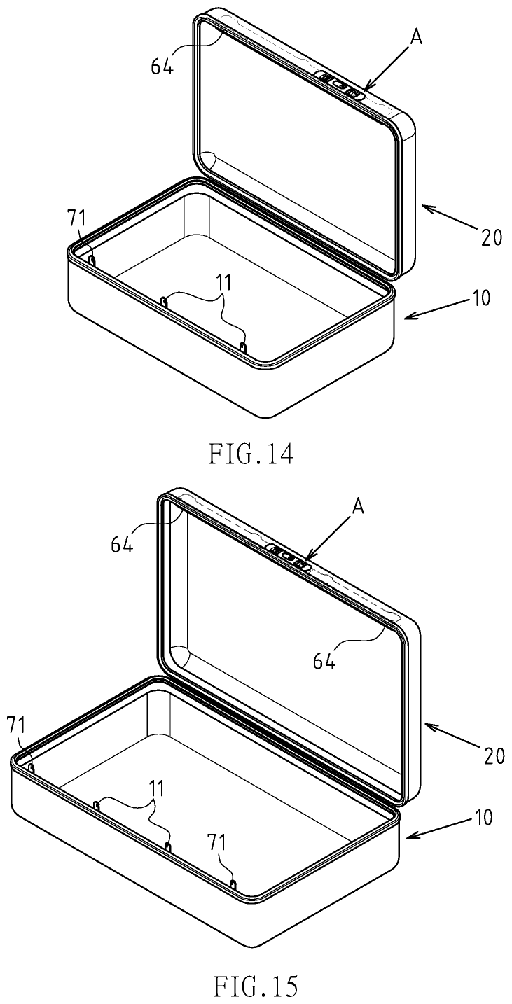

As shown in FIGS. 14 and 15, in this case, at least one auxiliary locating hook 70 is provided at the gap of at least one of the two locating hooks 11 of the first case 10, so that the corresponding linked buckle component 60 (see FIG. 4) is provided with at least one auxiliary buckle part 64 to be stuck in the corresponding auxiliary locating hook 70 of the first case 10; in this case, FIG. 14 discloses the implementation pattern of one auxiliary locating hook 70 and one auxiliary buckle part 64; FIG. 15 discloses the implementation pattern of two auxiliary locating hooks 70 and two auxiliary buckle parts 64. Said auxiliary locating hook 70 and auxiliary buckle part 64 are added in this case, because when the width of case body is large, the spaced locating points formed by the two locating hooks 11 are difficult to implement better localization, the technical features disclosed in this case can be used to increase the case body close locating points, the firmness of the case body in closed state is better, the product quality is improved.

Wherein the first case 10 and the second case 20 have symmetric or asymmetric volume capacity; as shown in FIG. 1, the first case 10 has larger volume capacity than the second case 20, it is an asymmetric configuration.

Wherein said case body is a suitcase, a cosmetics case or a toolbox with storage function.

I claim:

1. A case body with a double-toggle lockset, comprising:
a first case and a second case which are pivoted on each other, wherein the second case has a lift side, the first case has two spaced locating hooks, the two locating hooks correspond to the lift side of the second case;
a double-toggle lockset, installed on the lift side of the second case, the double-toggle lockset comprises:
a casing holder with a storage space and an operation panel;
a core located somewhere in the storage space of the casing holder, the core comprises an operating part and a locking component, the locking component has a lock mode and a release mode, the operating part is exposed on the operation panel of the casing holder, and the operating part is used to switch said lock mode or release mode of the locking component;
two pull parts located in the storage space of the casing holder, symmetrically spaced on two opposite sides of the core, each pull part comprises a toggle, a guide base, a brake part and an elastic reset piece, wherein the toggle is exposed on the operation panel of the casing holder for the finger to pull, the guide base is connected to the toggle, so that the guide base and the toggle move synchronously, the brake part is connected to a position of the guide base, the brake part fits the locking component of the core, the locking component in said lock mode or release mode localizes or moves the brake part together with the toggle and the guide base; the elastic reset piece is located between a fixed part and the guide base in the storage space, so that the actuation of the guide base and the toggle can be resetted automatically; and
two linked buckle components, located in the storage space of the casing holder and on opposite outer sides of the two pull parts respectively, each linked buckle component comprises a moved part, a buckle part and an extended interlocking frame between the moved part and the buckle part, wherein the moved part is connected to the guide base of the corresponding pull part, the buckle part is stuck in the corresponding locating hook of the first case, so as to localize the second case covering the first case; and wherein the distance between the toggles of the two pull parts is in the range which allows a normal adult to pull the toggles with one hand.

2. The case body with a double-toggle lockset defined in claim 1, wherein the operating part of the core is key turn on/off type, the locking component is a T-bar which turns synchronously with the operating part; the brake parts of the two pull parts are laterally protruding bolts, and the brake parts of the two pull parts are vertically dislocated and spaced; said lock mode is formed when the locking component turns to an upright angle, the brake parts of the two pull parts are localized; said release mode is formed when the locking component turns to a transverse angle, so that the brake parts of the two pull parts are released for actuation.

3. The case body with a double-toggle lockset defined in claim 1, wherein the operating part of the core is coded lock on/off type, the locking component comprises a rotary knob and a swing frame, wherein one end of the rotary knob has a bevel guide face, there are two propping parts on two opposite sides of the swing frame for the moved parts of the two linked buckle components to prop, and one side of the swing frame is provided with a pushed part which cooperates with the bevel guide face of the rotary knob, when the coded lock on/off type operating part is in unlock status, the swing frame can swing, and the locking component is in release mode. In this state, the rotary knob is turned, the bevel guide face pushes the pushed part, the two propping parts of the swing frame shift, so that the moved parts of the two linked buckle components are released for actuation.

4. The case body with a double-toggle lockset defined in claim 2, wherein a guide cavity for holding an elastic underprop component is provided near the buckle part of the linked buckle component in the storage space of the casing holder, the elastic underprop component comprises an underprop holder and an elastic piece, wherein the end of the underprop holder props the end of the corresponding locating hook of the first case, when the buckle part of the linked buckle component is disengaged from the locating hook of the first case, under the elastic underpropping effect of the elastic underprop component on the locating hook, the second case is pulled off the first case automatically to form a spacing.

5. The case body with a double-toggle lockset defined in claim 3, wherein a guide cavity for holding an elastic underprop component is provided near the buckle part of the linked buckle component in the storage space of the casing holder, the elastic underprop component comprises an underprop holder and an elastic piece, wherein the end of the underprop holder props the end of the corresponding locating hook of the first case, when the buckle part of the linked buckle component is disengaged from the locating hook of the first case, under the elastic underpropping effect of the elastic underprop component on the locating hook, the second case is pulled off the first case automatically to form a spacing.

6. The case body with a double-toggle lockset defined in claim 1, wherein at least one auxiliary locating hook is provided at the gap of at least one of the two locating hooks of the first case, so that the corresponding linked buckle component is provided with at least one auxiliary buckle part to be stuck in the corresponding auxiliary locating hook of the first case.

7. The case body with a double-toggle lockset defined in claim 1, wherein the first case and the second case have symmetric or asymmetric volume capacity.

8. The case body with a double-toggle lockset defined in claim 1, wherein said case body is a suitcase, a cosmetics case or a toolbox with storage function.
